(19) United States
(12) Patent Application Publication
(10) Pub. No.: US 2015/0064456 A1
(43) Pub. Date: Mar. 5, 2015

(54) HARD-COAT WINDOW AND TOUCH PANEL INCLUDING THE SAME

(71) Applicant: Samsung Display Co., Ltd., Yongin-city (KR)

(72) Inventor: Toru Kimura, Yongin-city (KR)

(21) Appl. No.: 14/457,785

(22) Filed: Aug. 12, 2014

(30) Foreign Application Priority Data
Aug. 27, 2013 (KR) 10-2013-0101886

(51) Int. Cl. G02B 1/10; G02F 1/1333

(52) U.S. Cl. CPC G02B 1/105; G02F 1/133345; G02F 1/13338
USPC 428/336; 428/446

(57) ABSTRACT

A hard coat window and a touch panel including the same includes: a base substrate; a first layer formed on the base substrate; and a second layer formed on the first layer, wherein the second layer is made of a carbon-injected silicon oxide (SiOC) layer.

### CROSS REFERENCE TO RELATED APPLICATION

This application claims priority from and the benefit of Korean Patent Application No. 10-2013-0101886, filed on Aug. 27, 2013, which is hereby incorporated by reference for all purposes as if fully set forth herein.

### BACKGROUND

1. Field

Exemplary embodiments of the present invention relate to a hard coat window and a touch panel including the same.

2. Discussion of the Background

Flat panel displays such as liquid crystal displays (LCD) or organic light emitting diode (OLED) displays have been developed. Further, a touch panel has been mounted on the flat panel display as a means for user input.

A hard coat window is typically formed over the touch panel to protect the touch panel from an external impact. A sputtering method or a post-processing method has been used to form the hard coat window.

A general method for forming a transparent hard coat window by the sputtering method is to form a silicon dioxide (SiO₂) layer in an atmosphere of mixed gas of argon (Ar) and oxygen (O₂), with silicon (Si) as a target.

However, as flat panel displays including a touch panel have been further developed, there has become a demand for development of a hard coat window that is stronger than a silicon dioxide layer, allows no scratches, and has superior chemical resistance.

The above information disclosed in this Background section is only for enhancement of understanding of the background of the invention and therefore it may contain information that does not form the prior art that is already known in this country to a person of ordinary skill in the art.

### SUMMARY

Exemplary embodiments of the present invention provide a stronger hard coat window to guard against an external impact. Exemplary embodiments of the present invention also provide a hard coat window with increased scratch and chemical resistance, and a touch panel including the hard coat window.

Additional features of the invention will be set forth in the description that follows, and in part will be apparent from the description, or may be learned by practice of the invention.

An exemplary embodiment of the present invention discloses a hard coat window and a touch panel including the same including a base substrate, a first layer formed on the base substrate, and a second layer formed on the first layer. The second layer is made of a carbon-injected silicon oxide (SiOC; silicon oxycarbide) layer.

An exemplary embodiment of the present invention also discloses a touch panel including a touch unit, a base substrate formed on a surface of the touch unit, a first layer formed on the base substrate, and a second layer formed on the first layer. The second layer is made of a carbon-injected silicon oxide (SiOC) layer.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 shows a cross-sectional view of a hard coat window according to an exemplary embodiment of the present invention.

FIG. 2 shows a cross-sectional view of a touch panel including a hard coat window according to an exemplary embodiment of the present invention.

FIG. 3 shows a graph of a result of one experimental example of the present invention.

FIG. 4 shows a graph of a result of one experimental example of the present invention.

FIG. 5 shows a graph of a result of one experimental example of the present invention.

### DETAILED DESCRIPTION OF THE ILLUSTRATED EMBODIMENTS

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

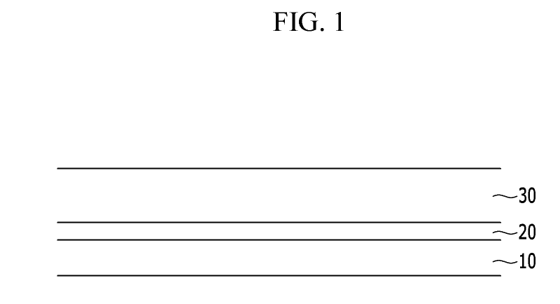

Referring to FIG. 1, a hard coat window according to an exemplary embodiment of the present invention will now be described in detail. FIG. 1 shows a cross-sectional view of a hard coat window according to an exemplary embodiment of the present invention.

Referring to FIG. 1, the hard coat window includes a first layer 20 disposed a transparent base substrate 10 and a second layer 30 disposed on the first layer 20.

The base substrate 10 may be transparent, including, for example, at least one of transparent plastic and transparent glass.

The first layer 20 may include silicon nitride (SiN), and the second layer 30 may include carbon-injected silicon oxide (SiOC).

A thickness of the first layer 20 may be in a range of about 3 nm to 10 nm, and a thickness of the second layer 30 may be in a range of about 100 nm to 500 nm.

The first layer 20 may be an adhesive layer. The second layer 30 may be a hard coat layer.

According to a method for manufacturing a hard coat window according to an exemplary embodiment of the present invention, in the atmosphere of mixed gas of argon (Ar), oxygen (O₂), methane (CH₄), and nitrogen (N₂), the first layer 20 (the adhesive layer), and the second layer 30 (the hard coat layer) are deposited with silicon (Si) as a target through sputtering.

Thus, the second layer 30 (the hard coat layer) is formed with a carbon-injected silicon oxide (SiOC) layer so it is durable to external impacts, and increases scratch and chemical resistance.

During formation, a vacuum degree of a deposition device may be below 1.0×10⁻³ Pa, and a deposition temperature can be in a range of about 50° C. to 150° C. The atmospheric gas may be a mixed gas of argon (Ar) and nitrogen (N₂) with a partial pressure in a range of about 1% to 20%, a mixed gas of argon (Ar) and oxygen (O₂) with a partial pressure in a range of about 1% to 20%, and methane (CH₄) with a partial pressure in a range of about 1% to 20%.

In detail, the mixed gas of argon (Ar) and nitrogen (N₂) with a partial pressure in a range of about 1% to 20% is supplied at a pressure in a range of about 2.7-¹ Pa to 3.7×10⁻¹ Pa in a vacuum chamber exhausted to below 1×10⁻³ Pa, and a material with silicon (Si) as a target is disposed within the chamber to form the first layer 20 of the adhesive layer having a thickness in a range of about 3 nm to 10 nm.

Then, a mixed gas of argon (Ar) and oxygen (O₂) with a partial pressure in a range of about 1% to 20%, and methane (CH₄) with a partial pressure in a range about 1% to 20%, is supplied at a pressure in a range of about 2.7⁻¹ Pa to 3.7×10⁻¹ Pa. A material with silicon (Si) as a target disposed in the vacuum chamber is used to form the second layer 30 of the hard coat layer.

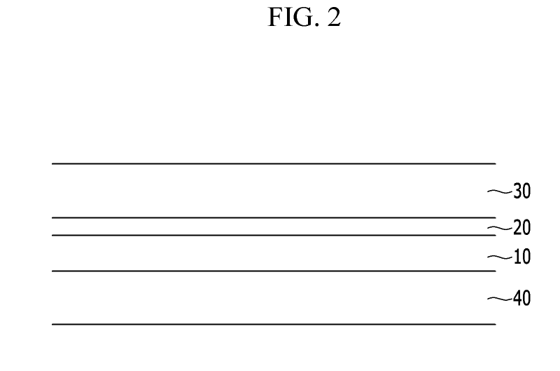

A touch panel including a hard coat window according to an exemplary embodiment of the present invention will now be described with reference to FIG. 2. FIG. 2 shows a cross-sectional view of a touch panel including a hard coat window according to an exemplary embodiment of the present invention.

Referring to FIG. 2, the touch panel includes a touch unit 40 disposed on one side of the base substrate 10, a first layer 20 disposed on another side of the base substrate 10, and a second layer 30 disposed on the first layer 20.

The base substrate 10 may be transparent and may include, for example, at least one of transparent plastic and transparent glass.

The first layer 20 may be made of silicon nitride (SiN), and the second layer 30 may be made of a carbon-injected silicon oxide (SiOC) layer.

A thickness of the first layer 20 may be in a range of about 3 nm to 10 nm, and a thickness of the second layer 30 may be in a range of about 100 nm to 500 nm.

The first layer 20 may be an adhesive layer. The second layer 30 is a hard coat layer.

As described, the touch panel includes the base substrate 10 disposed on the touch unit 40, the first layer 20 (the adhesive layer) disposed on the base substrate 10, and the second layer 30 (the hard coat layer) disposed on the first layer 20. The first layer 20 includes silicon nitride (SiN), and the second layer 30 includes carbon-injected silicon oxide (SiOC).

Since the second layer 30 (the hard coat layer) of the touch panel, includes carbon-injected silicon oxide (SiOC), it is strong against external impacts, and has increased scratch and chemical resistance.

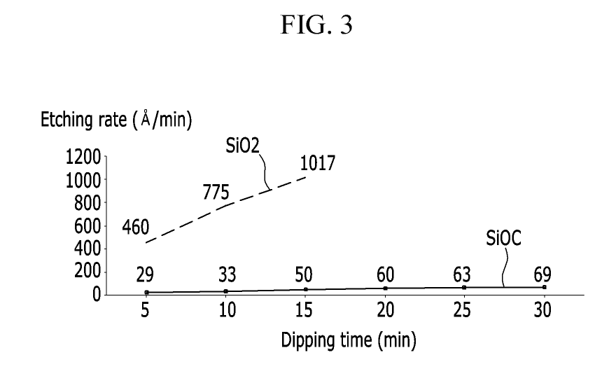

Referring to FIG. 3 to FIG. 5, a result of one experimental example of the present invention will now be described. FIG. 3 to FIG. 5 show graphs of a result of one experimental example of the present invention.

In the present experimental example, characteristics of the carbon-injected silicon oxide (SiOC) layer (the hard coat layer) of the present disclosure and a silicon dioxide (SiO₂) layer (a conventional hard coat layer) are compared.

First, in order to compare the chemical resistance of the carbon-injected silicon oxide (SiOC) layer and the silicon dioxide (SiO₂) layer, a buffered oxide etch, buffered HF (BHF) with substantially 0.4 wt %, is used to measure an etching speed change with respect to a time of dipping the BHF, and the result is shown in FIG. 3.

Referring to FIG. 3, when the carbon-injected silicon oxide (SiOC) layer and the silicon dioxide (SiO₂) layer are compared, it is found that the etching speed change in the SiOC layer is comparatively small. Thus, the experiment shows chemical resistance is increased by approximately 200% in the SiOC layer compared with the SiO₂ layer.

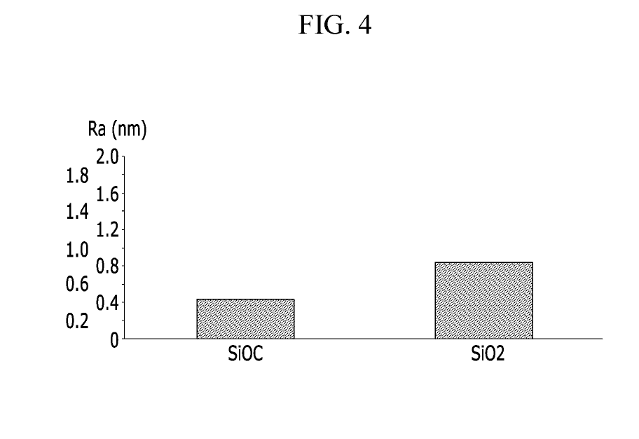

Next, to measure a characteristic of layer surfaces of the carbon-injected silicon oxide (SiOC) layer, and the silicon dioxide (SiO₂) layer, an atomic force microscope (AFM) is used to measure average surface roughness (Ra) for indicating surface morphology. The result is shown in FIG. 4. Additionally, friction coefficients of the carbon-injected silicon oxide (SiOC) layer, and the silicon dioxide (SiO₂) layer were measured four times, and the result is shown in Table 1.

Referring to FIG. 4, when the carbon-injected silicon oxide (SiOC) layer, is compared to the silicon dioxide (SiO₂) layer, it is found that the surface roughness is substantially reduced in the SiOC layer. More specifically, the surface roughness is reduced by a factor of approximately 1.9 times in the SiOC layer when compared to the SiO₂ layer.

TABLE 1

| | Friction coefficient (LF/NF) (μN/μN) | | | | |
|---|---|---|---|---|---|
| | (LF: lateral force/NF: normal force) | | | | |
| Layer | 1 | 2 | 3 | 4 | Average |
| Carbon-injected silicon oxide | 0.22 | 0.22 | 0.22 | 0.22 | 0.22 |
| (SiOC) layer | | | | | |
| Silicon dioxide (SiO₂) layer | 0.25 | 0.25 | 0.25 | 0.25 | 0.25 |

Referring to Table 1, when the carbon-injected silicon oxide (SiOC) layer is compared to the silicon dioxide (SiO₂) layer, it is found that the friction coefficient is reduced. More specifically, the friction coefficient is reduced by about 13% in the SiOC layer when compared to the SiO₂ layer.

As described, compared to the silicon dioxide (SiO₂) layer, the carbon-injected silicon oxide (SiOC) layer has reduced surface roughness and friction coefficient. These reduced characteristics result in an improved layer surface.

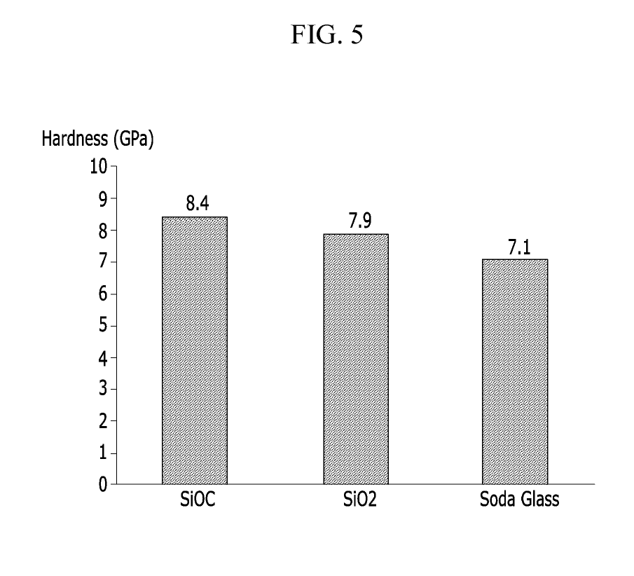

Next, layer hardness of the carbon-injected silicon oxide (SiOC) layer and the silicon dioxide (SiO₂) layer were measured and the result is shown in FIG. 5.

Referring to FIG. 5, when the carbon-injected silicon oxide (SiOC) layer is compared to the silicon dioxide (SiO₂) layer, the hardness of the SiOC layer is greater. More specifically, the layer hardness of the SiOC layer is increased by approximately 6% over the SiO₂ layer.

As described, when the silicon dioxide (SiO₂) layer, a conventional hard coat layer, is compared to the carbon-injected silicon oxide (SiOC) layer, a hard coat layer of the hard coat window according to the exemplary embodiment of the present invention, the chemical resistance of the carbon-injected silicon oxide (SiOC) layer is improved by approximately 200%, the average surface roughness is reduced by approximately 1.9 times, the friction coefficient is reduced by approximately 13%, and the layer hardness is improved by approximately 6%.

Therefore, when the hard coat window according to the present exemplary embodiment and the touch panel including the same, is formed with the carbon-injected silicon oxide (SiOC) layer, it has increased strength against external impact, and improved chemical and scratch resistance.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A hard coat window, comprising:
a substrate;
a first layer disposed on the substrate; and
a second layer disposed on the first layer,
wherein the second layer comprises carbon-injected silicon oxide (SiOC).

2. The hard coat window of claim 1, wherein the first layer comprises silicon nitride (SiN).

3. The hard coat window of claim 2, wherein a thickness of the first layer is in a range of 3 nm to 10 nm, and a thickness of the second layer is in a range of 100 nm to 500 nm.

4. The hard coat window of claim 1, wherein a thickness of the first layer is in a range of 3 nm to 10 nm, and a thickness of the second layer is in a range of 100 nm to 500 nm.

5. A touch panel, comprising:
a touch unit;
a substrate disposed on the touch unit;
a first layer disposed on the substrate; and
a second layer disposed on the first layer,
wherein the second layer comprises carbon-injected silicon oxide (SiOC).

6. The touch panel of claim 5, wherein the first layer comprises silicon nitride (SiN).

7. The touch panel of claim 6, wherein a thickness of the first layer is in a range of 3 nm to 10 nm, and a thickness of the second layer is in a range of 100 nm to 500 nm.

8. The touch panel of claim 5, wherein a thickness of the first layer is in a range of 3 nm to 10 nm, and a thickness of the second layer is in a range of 100 nm to 500 nm.

9. The hard coat window of claim 2, wherein the second layer is disposed directly on the first layer.

10. The touch panel of claim 6, wherein the second layer is disposed directly on the first layer.
